(19) United States
(12) Patent Application Publication
(10) Pub. No.: US 2015/0161217 A1
(43) Pub. Date: Jun. 11, 2015

(54) RELATED IMAGES

(71) Applicants: Yong Zhang, Shanghai (CN); Guang Hua Li, Shanghai (CN); Gangjiang Li, Shanghai (CN); Hui Li, Shanghai (CN); Boon-Lock Yeo, Los Altos Hills, CA (US)

(72) Inventors: Yong Zhang, Shanghai (CN); Guang Hua Li, Shanghai (CN); Gangjiang Li, Shanghai (CN); Hui Li, Shanghai (CN); Boon-Lock Yeo, Los Altos Hills, CA (US)

(73) Assignee: GOOGLE INC., Mountain View, CA (US)

(21) Appl. No.: 12/767,651

(22) Filed: Apr. 26, 2010

(51) Int. Cl. G06F 17/30; G06K 9/62

(52) U.S. Cl. CPC G06F 17/30554; G06K 9/6215; G06F 17/30256

(57) ABSTRACT

Methods, systems, and apparatus, including computer programs encoded on a computer storage medium, for detecting related images.

### BACKGROUND

This specification relates to identifying related images.

Internet search engines provide information about Internet accessible resources (e.g., web pages, images, text documents, and multimedia content) that are responsive to users' queries by returning search results in response to the queries. A search result includes, for example, a Uniform Resource Locator (URL) and a snippet of information for a resource responsive to a query. The search results can be ranked according to scores assigned to the search results by a scoring function. The scoring function ranks the search results according to various signals, for example, where (and how often) query terms appear in the search results and how common the query terms are in the search results indexed by the search engine.

### SUMMARY

In general, one innovative aspect of the subject matter described in this specification can be embodied in methods that include the actions of determining a number of occurrences of unique image pairs wherein each image pair corresponds to a first image and a second image, both of which were represented in a plurality of search results responsive to a respective query for a plurality of users, wherein the first image was selected by a respective user a respective amount of time before or after the second image was selected by the respective user; receiving data indicative of user selection of an image search result and selecting one or more of the unique image pairs whose first image matches the selected image and having a number of occurrences that satisfies a threshold; and providing second images from one or more of the selected unique image pairs in response to the user-selection of the image. Other embodiments of this aspect include corresponding systems, apparatus, and computer programs, configured to perform the actions of the methods, encoded on computer storage devices.

These and other embodiments can each optionally include one or more of the following features. Respective queries of one or more of the selected unique image pairs can be provided. The provided second images can be from a same website or from a same webpage. The unique image pairs do not include image pairs where the amount of time before or after selection of the second image of the pair is beyond a threshold. Providing the second images can comprise ordering the second images based on the respective amounts of time of the second images or based on the frequency counts associated with the second images. The number of unique image pairs does not include image pairs that were presented in search results before a particular date. Each first image is viewed at least a threshold amount of time. The first image is determined to be pornographic and the second images are identified as being pornographic responsive to the determining.

Particular embodiments of the subject matter described in this specification can be implemented so as to realize one or more of the following advantages. When a user selects an image result responsive to a query, images related to the selected image can be shown. The related images can be from the same site or domain as the selected image result or from different sites/domains if the different sites/domains are semantically related. Queries derived from the related images can also be presented. Related images can be used to suggest images and for pornographic image detection.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A illustrates an image search user interface as displayed in an example graphical user interface as presented in a web browser or other software application.

FIG. 1B illustrates image search results as displayed in an example graphical user interface as presented in a web browser or other software application.

FIG. 2 illustrates related image results as displayed in an example graphical user interface as presented in a web browser or other software application.

FIG. 3 illustrates an example search system for identifying related images as can be implemented in an Internet, intranet, or other client/server environment.

FIG. 4 is a flow diagram of an example technique for providing related images.

FIG. 5 is a schematic diagram of an example system configured to provide related images.

Like reference numbers and designations in the various drawings indicate like elements.

### DETAILED DESCRIPTION

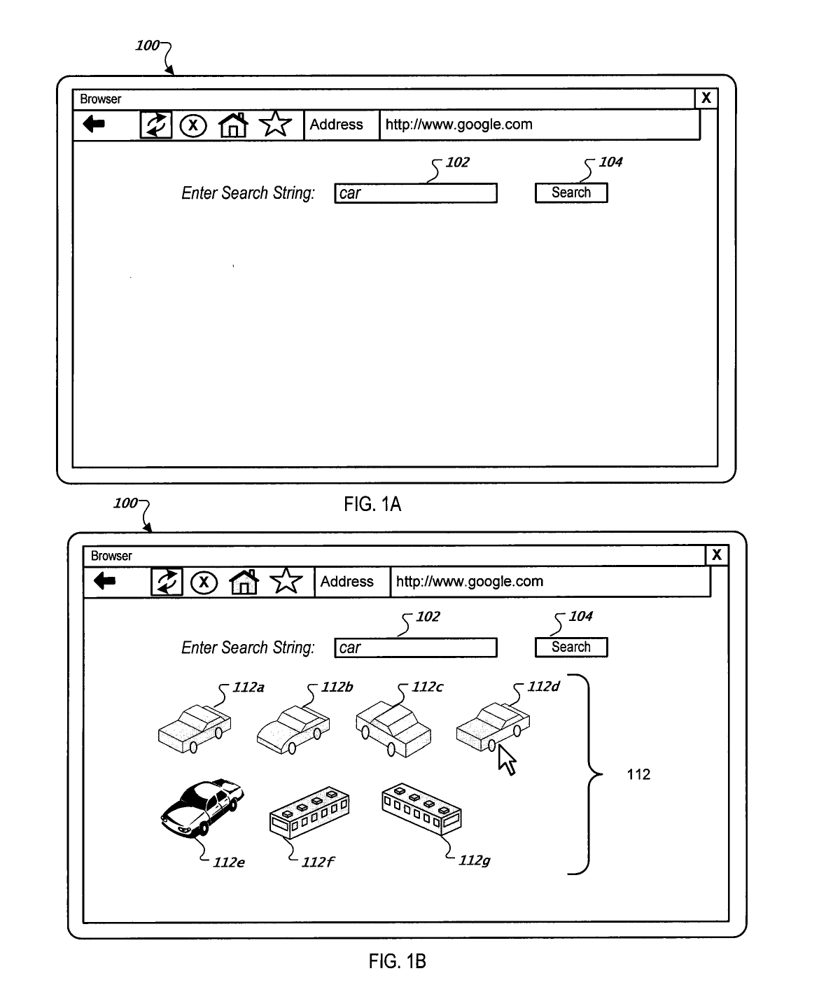

FIG. 1A illustrates an image search user interface as displayed in an example graphical user interface (GUI) 100 as presented in a web browser or other software application. The GUI 100 includes a text entry field 102 which accepts queries from users when a search button 104 is selected, for instance. Queries can be text (e.g., “car”) or speech that specifies general or specific topics or other information. Alternatively, queries can comprise images or videos. A submitted query is transmitted to a search engine which identifies resources (e.g., images) that are responsive to the query in an index of resources of the world wide web or other corpus and then transmits search results 112a-g to the web browser for presentation in region 112 of the GUI 100 (FIG. 1B).

As used herein, a resource is any data that can be provided over a network and that is associated with a resource address such as a URL, for instance. Resources include Hypertext Markup Language (HTML) pages, word processing documents, portable document format (PDF) documents, electronic books, audio content, images, videos, electronic games, and feed sources, to name just a few. Images can be stored in a number of formats including, for instance, raster bitmap, Joint Photographic Experts Group (JPEG), JPEG File Interchange Format (JFIF), Tagged Image File Format (TIFF), raw image formats, Portable Network Graphics (PNG), Graphics Interchange Format (GIF), vector format, and others.

The resources themselves can include content, e.g., words, phrases, images and sounds and may include embedded information (e.g., meta information and hyperlinks) and/or embedded instructions (e.g., JavaScript scripts). Moreover, a resource may be stored at the location in a portion of a file that holds other content, in a single file dedicated to the resource in question, or in multiple coordinated files. A resource may, but need not, correspond to a file.

Search results 112 can be ranked according to traditional techniques for determining an information retrieval (IR) score for indexed resources in view of a given query, for example. The relevance of a particular resource with respect to a particular search term or other provided information may be determined by any appropriate scoring technique.

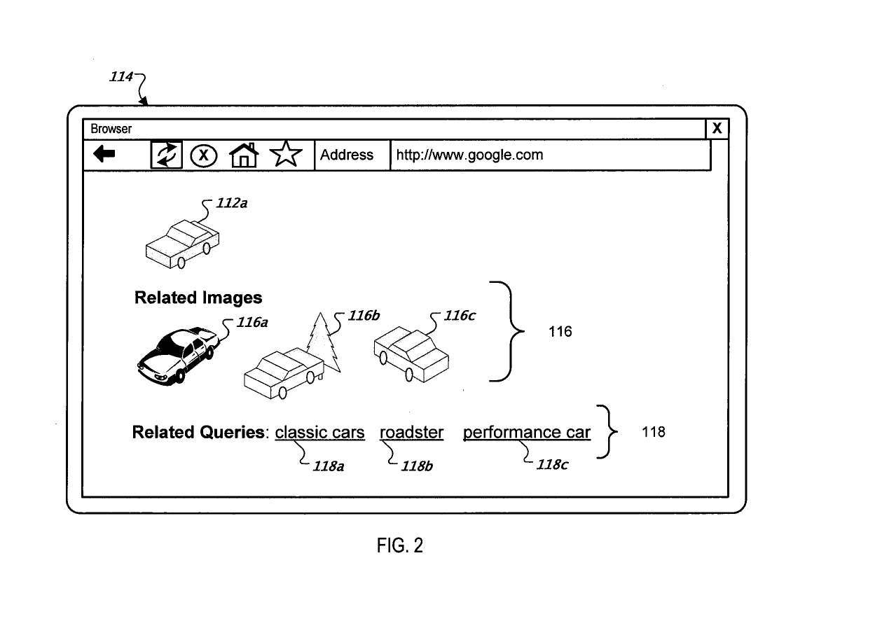

Each search result 112a-g is a scaled-down (“thumbnail”) or full size version of an image that is responsive to the query 102. A user can select a search result (e.g., thumbnail 112a) with a mouse click, a finger gesture on a touch-sensitive surface, a speech command to a microphone, or by way of another input device, for example, in order to view the image identified by the search result. In some implementations, selection of a search result will cause a set of images related to the selected search result to be displayed. By way of illustration, GUI 114 (FIG. 2) presents the user's selected image result 112a along with a set of thumbnail icons of related images 116a-c in region 116 of the GUI 114. In further implementations, a set of related queries can be presented in region 118 of the web page 114. The following sections describe how related images and their associated queries can be identified.

TABLE 1
User Activity

| | T1 | T2 | T3 | T4 | T5 | T6 | T7 |
|---|---|---|---|---|---|---|---|
| User 1 | Q₁ | I₁ | I₂ | I₃ | Q₂ | I₄ | I₅ |
| User 2 | | Q₃ | I₁ | | I₂ | | I₃ |
| User 3 | Q₄ | I₁ | I₂ | I₃ | I₄ | | |

A “co-clicked image” is an image search result responsive to a query that is selected by a user within some amount of time (e.g., below a threshold such as, for instance 10 minutes) before or after selection of another image search result (or “reference image”) for the same query. By way of illustration, and with reference to TABLE 1 above, User 1 submits query Q₁ at time T1 (e.g., by selecting the search button 104 on GUI 100) and then selects Q₁ image search result I₁ at time T2 (e.g., by selecting an image search result in GUI 100). User 1 then selects Q₁ image search result I₂ at time T3, and Q₁ image search result I₃ at time T4. At time T5 User 1 submits query Q₂ and then selects Q₂ image search results I₄ and I₅ at times T6 and T7, respectively. User 2 submits query Q₃ at time T2 and then selects Q₃ image search results I₁ and I₂ at times T3 and T5, respectively. Finally, User 3 submits query Q₄ at time T1 and then selects images responsive to Q₄: image I₁ at time T2, image I₂ at time T3, image I₃ at time T4, and image I₄ at time T5. Note that the queries and image results in TABLE 1 can be duplicative as can the images. However, a reference image and a co-clicked image cannot be identical. In some implementations, two images are identical if they have the same resource address. In further implementations, two images are identical if their image content is identical or substantially identical (within some threshold).

TABLE 2A
Reference/Co-clicked Image Tuples (assumes a co-clicked
image is selected after the reference image)

| USER 1 | USER 2 | USER 3 |
|---|---|---|
| (Q₁, I₁, I₂, 1Δ) | (Q₃, I₁, I₂, 2Δ) | (Q₄, I₁, I₂, 1Δ) |
| (Q₁, I₁, I₃, 2Δ) | (Q₃, I₁, I₃, 4Δ) | (Q₄, I₁, I₃, 2Δ) |
| (Q₁, I₂, I₃, 1Δ) | (Q₃, I₂, I₃, 2Δ) | (Q₄, I₁, I₄, 3Δ) |
| (Q₂, I₄, I₅, 1Δ) | | (Q₄, I₂, I₃, 1Δ) |
| | | (Q₄, I₂, I₄, 2Δ) |
| | | (Q₄, I₃, I₄, 1Δ) |

TABLE 2B
Reference/Co-clicked Image Tuples (assumes a co-
clicked image is selected before a reference image)

| USER 1 | USER 2 | USER 3 |
|---|---|---|
| (Q₂, I₅, I₄, 1Δ) | (Q₃, I₃, I₂, 2Δ) | (Q₄, I₄, I₃, 1Δ) |
| (Q₁, I₃, I₂, 1Δ) | (Q₃, I₃, I₁, 4Δ) | (Q₄, I₄, I₂, 2Δ) |
| (Q₁, I₃, I₁, 2Δ) | (Q₃, I₂, I₁, 2Δ) | (Q₄, I₃, I₂, 1Δ) |
| (Q₁, I₂, I₁, 1Δ) | | (Q₄, I₄, I₁, 3Δ) |
| | | (Q₄, I₃, I₁, 2Δ) |
| | | (Q₄, I₂, I₁, 1Δ) |

Each selection of an image result can be recorded as a tuple as illustrated in TABLES 2A or 2B above depending on whether a co-clicked image is assumed to occur after selection of a reference image (TABLE 2A) or before selection of a reference image (TABLE 2B). Each tuple includes a query, the reference image, the co-clicked image, and the time difference between selection of the reference image and selection of the co-clicked image. For ease of illustration, time differences are shown as multiples of a delta amount A. In some implementations, time differences are maintained as seconds or minutes. Other time representations are possible. For instance, and with reference to TABLE 2A, tuple (Q₁, I₁, I₂, 1Δ) for User 1 indicates that image results I₁ and I₂ were responsive to query Q₁ and that co-clicked image I₂ was selected 1Δ after reference image I₁. Tuple (Q₃, I₁, I₃, 4Δ) for User 2 indicates that image results I₁ and I₃ were responsive to query Q₃ and that co-clicked image I₃ was selected 3Δ's after reference image I₁. In some implementations, the time that a user views a selected image search result before returning to the search results list is recorded and only those selected image search results having viewing times greater than an adjustable threshold (e.g., 20 seconds) are counted as image selections for purposes of recording tuples. The idea being that the longer a user views an image result, the more relevant the result probably is for the query.

TABLE 3
Unique Image Pairs

| UNIQUE PAIR | COUNT |
|---|---|
| I₁, I₂ | 3 |
| I₁, I₃ | 2 |
| I₂, I₃ | 3 |
| I₂, I₄ | 1 |
| I₃, I₄ | 1 |
| I₄, I₅ | 1 |

The recorded tuples can then be analyzed to determine the number of each unique image result pairs (or “frequency”), regardless of query and user. For example, the image result pair I₁, I₂ occurs three times in TABLE 2A: (Q₁, I₁, I₂, 1Δ), (Q₃, I₁, I₂, 2Δ), (Q₄, I₁, I₂, 1Δ). In some implementations, if the time period between image result selections is above a threshold amount of time, the tuple is not counted in the number of unique image pairs. The image pairs in TABLE 3 assumes that the threshold amount of time is 2Δ, which is why tuples (Q₃, I₁, I₃, 4Δ) and (Q₄, I₁, I₄, 3Δ) are not counted. If a given unique pair has a count that is above a threshold number (e.g., 100), then the co-clicked image in that pair is considered related to the reference image of the pair. The threshold can be decreased for a unique pair if the unique pair contains a new image in order to help promote fresh related images. In further implementations, if two unique image pairs (Q₁₃₄₃, I_{w}, Iₓ, Δ) and (Q₄₄₂, I_{y}, I_{z}, Δ) each have an image in the same position and the images (e.g., I_{y} and I_{w}) have different resource addresses but have identical content, then each pair can contribute to the count of the other. In yet further implementations, tuples that are older than an adjustable age (e.g., 3 months) are not considered for purposes of determine unique image result pairs. Queries associated with the unique image pairs are considered related image queries. For pair (I₂, I₃), the related queries (from TABLE 2A) are Q₁, Q₃ and Q₄.

In further implementations, if a reference image is deemed to be pornographic, images related to it can be considered pornographic.

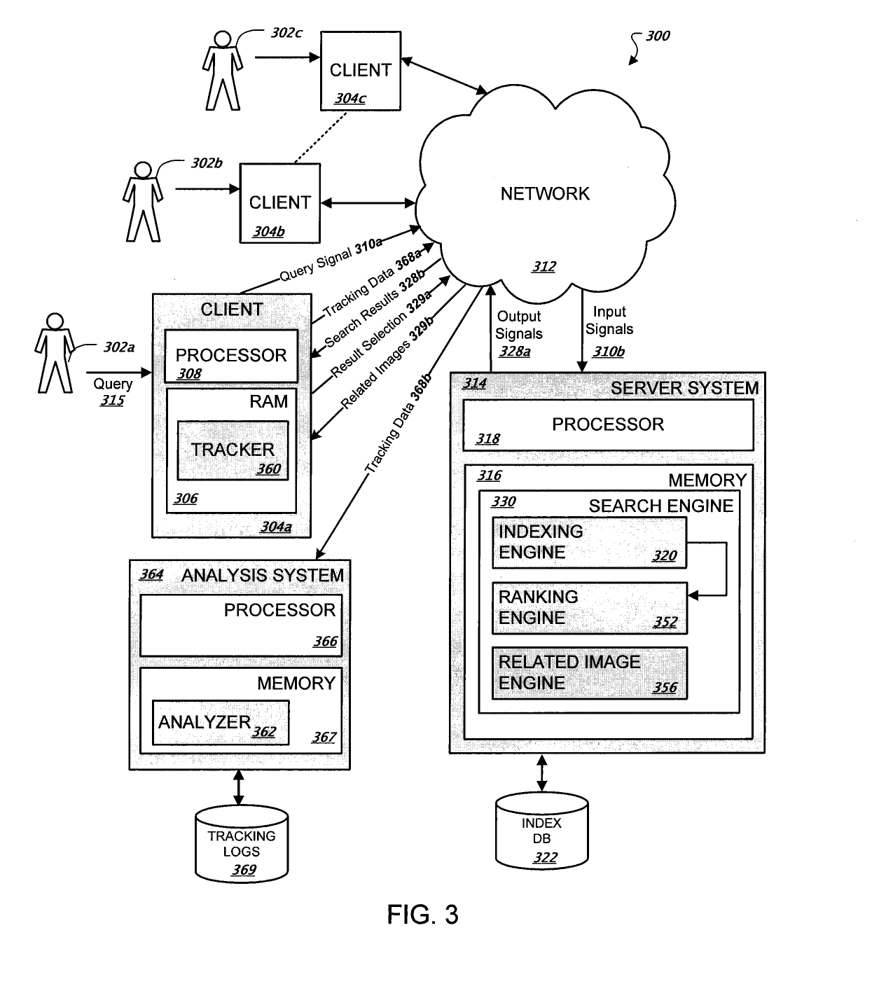

In various implementations, a system described below with reference to FIG. 3, maintains information regarding user interaction with image search results. When a user selects an image search result, the selection can be logged with the time of the selection, the amount of time the user viewed the image, the resource address of the image, and an identifier of the user such as an Internet Protocol (IP) address of the user's computer or a cookie value, for example. The information in TABLES 1-3 can be derived from this log, for example.

FIG. 3 illustrates an example search system 300 for identifying related images as can be implemented in an Internet, intranet, or other client/server environment. The system 300 is an example of an information retrieval system in which the systems, components and techniques described herein can be implemented. Although several components are illustrated, there may be fewer or more components in the system 300. Moreover, the components can be distributed on one or more computing devices connected by one or more networks or other suitable communication mediums.

A user 302 (302a, 302b, 302c) interacts with the system 300 through a client device 304 (304a, 304b, 304c) or other device. For example, the client device 304 can be a computer terminal within a local area network (LAN) or wide area network (WAN). The client device 304 generally includes a random access memory (RAM) 306 (or other memory and/or a storage device) and a processor 308. The processor 308 is structured to process instructions on the client device 304. The processor 308 is a single or multi-threaded processor having one or more processor cores, for example. The processor 308 is structured to process instructions stored in the RAM 306 (or other memory and/or a storage device included with the client device 304) to display graphical information for a user interface.

The RAM 306 on the client device 304 includes a tracker software program 360 for keeping track of image result selections on the client device 304. The tracker 360 can send the tracked data as a client-side signal 368a into the network 312 (e.g., the Internet or other network). The data is forwarded to an analysis system 364 as a server-side signal 368b. The analysis system 364 generally includes a RAM 367 (or other memory and/or a storage device) and a processor 366. The processor 366 is structured to process instructions on the analysis system 364. The processor 366 is a single or multi-threaded processor having one or more processor cores, for example. The RAM 367 includes an analyzer software program 362 for analyzing the tracking data 368b in order to calculate the numbers of unique image pairs. The tracking data 368b can be stored in one or more tracking logs 369 which are used to record the collected information for multiple users. In various implementations, the recorded information includes log entries that indicate the IP (Internet Protocol) address of the client 304 which transmitted the information, the time of selection of an image search result, the amount of time the user viewed the image, and the resource address of the image. Other data for log entries is possible.

A user 302a connects to the search engine 330 within a server system 314 to submit a query 315. When the user 302a submits the query 315 through an input device attached to a client device 304a, a client-side query signal 310a is sent into the network 312 and is forwarded to the server system 314 as a server-side input signal 310b. Server system 314 can be one or more server devices in one or more locations. A server device 314 includes a memory device 316, which can include the search engine 330 loaded therein. A processor 318 is structured to process instructions within the device 314. These instructions can implement one or more components of the search engine 330. The processor 318 can be a single or multi-threaded processor and can include multiple processing cores. The processor 318 can process instructions stored in the memory 316 related to the search engine 330 and can send information to the client devices 304a-c, through the network 312, to create a graphical presentation in a user interface of the client device 304 (e.g., a search results web page displayed in a web browser).

The server-side input signal 310b is received by the search engine 330. The search engine 330 uses the information within the user query 315 (e.g. query terms) to find relevant resources (e.g., images). The search engine 330 can include an indexing engine 320 that actively searches a corpus (e.g., resources on the Internet) to index the resources found in that corpus, and the index information for the resources in the corpus can be stored in an index database 322. This index database 322 can be accessed to identify resources related to the user query 315. The search engine 330 includes a ranking engine 352 to rank the resources related to the user query 315 using a scoring or ranking function. The ranking of the resources can be performed using traditional techniques for determining an information retrieval (IR) score for indexed resources in view of a given query, for example. The relevance of a particular resource with respect to a particular search term or to other provided information may be determined by any appropriate technique.

The search engine 330 forwards the ranked result list within a server-side search output signal 328a through the network 312. Exiting the network 312, a client-side search results signal 328b is received by the client device 304a where the results are stored within the RAM 306 and/or used by the processor 308 to display the results on an output device for the user 302a. The server system 314 may also maintain one or more user search histories based on the queries the server system 314 receives from a user, and from results that a user selected after a search was performed.

In some implementations, when a user selects a search result (e.g., 112g in FIG. 1B), a client-side result selection signal 329a identifying the selected search result is sent into the network 312 and is forwarded to the server system 314 as a server-side input signal 310b. The signal 310b is provided to a related image engine 356 which in response identifies images and/or queries related to the selected search result. In some implementations, the related image engine obtains the related images from the analyzer 362. In further implementations, the analyzer 362 is incorporated into the related image engine 356. The search engine 330 forwards the related images and/or queries within a server-side search output signal 328a through the network 312. Exiting the network 312, a client-side search related images signal 329b is received by the client device 304a where the results are stored within the RAM 306 and/or used by the processor 308 to display the results on an output device for the user 302a (e.g., as shown in FIG. 2).

The components shown in FIG. 3 can be combined in various manners and implemented in various system configurations. For example, the analyzer 362 and the related image engine 356 can be combined into a single component on the analysis system 364 or the server system 314. The related image engine 356 and the ranking engine 352 can also be merged, and in general, a ranking engine includes any software component that generates a ranking of resource results after a query. Moreover, a ranking engine can be included in a client system in addition to (or rather than) in a server system.

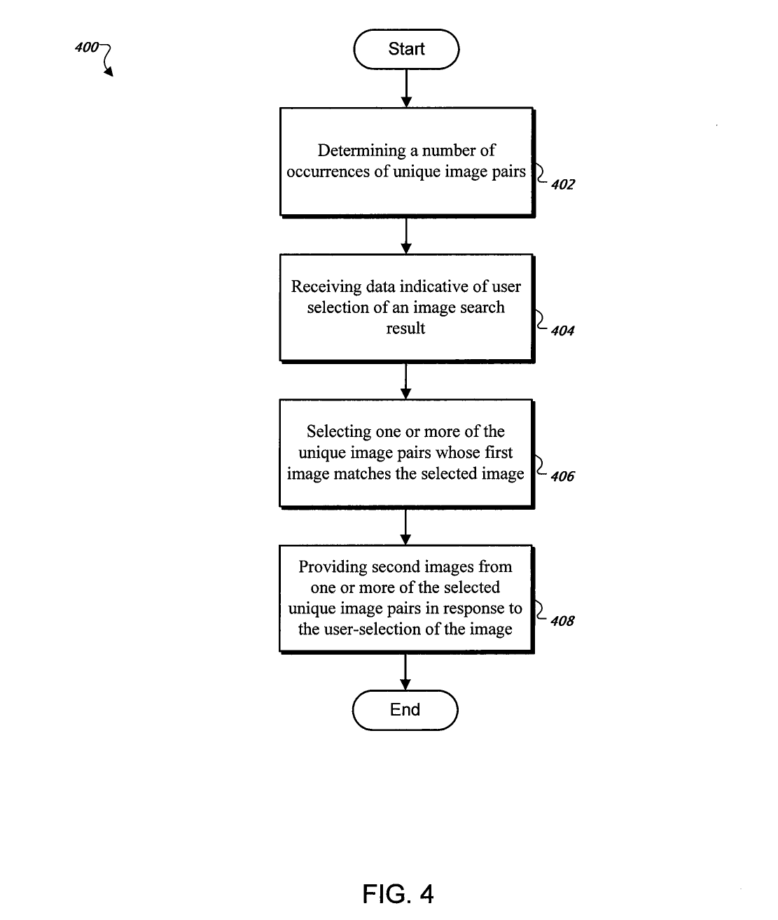

FIG. 4 is a flow diagram of an example technique 400 for providing related images. The technique determines a number of occurrences of unique image pairs wherein each image pair corresponds to a first image and a second image (step 402). See TABLE 3 above, for example. The first image and the second image in the pair were represented in search results responsive queries submitted by a number of users and the first image was selected by users before the second image. TABLE 1 illustrates user query submission and image result selection. In some implementations, the first image selected is viewed for a threshold amount of time. In other implementations, the time between selection of the first image and the second image is within an threshold amount of time. Data indicative of user selection of an image search result (e.g., 112a from FIG. 1B) is received (step 404). In some implementations, the data is received by the analysis system 364 of FIG. 3. One or more of the unique image pairs are selected whose first image matches the selected image and having a number of occurrences that satisfies a threshold (406). TABLE 3 lists example unique image pairs and their numbers of occurrences, for example. The second images from one or more of the selected unique image pairs are then provided (e.g., by the related image engine 356) in response to the user-selection of the image (step 408). In some implementations, the second images are provided in order of the frequency counts of their image pairs (see, e.g., TABLE 3).

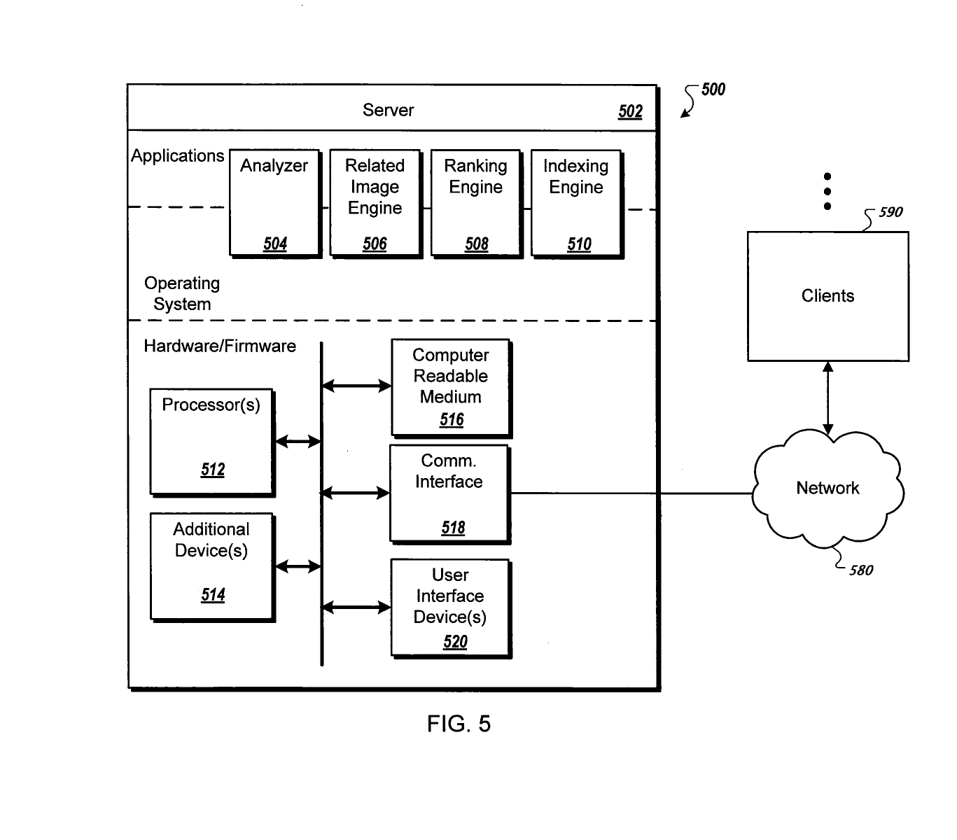

FIG. 5 is a schematic diagram of an example system configured to provide related images. The system generally consists of a server 502. The server 502 is optionally connected to one or more user or client computers 590 through a network 580. The server 502 consists of one or more data processing apparatus. While only one data processing apparatus is shown in FIG. 5, multiple data processing apparatus can be used. The server 502 includes various modules, e.g. executable software programs, including an analyzer 504 for analyzing user image search result selection data in order to determine related images. A related image engine 506 is configured to provide related images in response to user selection of an image search result. A ranking engine 508 ranks resources responsive to a query which were identified using one or more indexes maintained by the indexing engine 510.

Each module runs as part of the operating system on the server 502, runs as an application on the server 502, or runs as part of the operating system and part of an application on the server 502, for instance. Although several software modules are illustrated, there may be fewer or more software modules. Moreover, the software modules can be distributed on one or more data processing apparatus connected by one or more networks or other suitable communication mediums.

The server 502 also includes hardware or firmware devices including one or more processors 512, one or more additional devices 514, a computer readable medium 516, a communication interface 518, and one or more user interface devices 520. Each processor 512 is capable of processing instructions for execution within the server 502. In some implementations, the processor 512 is a single or multi-threaded processor. Each processor 512 is capable of processing instructions stored on the computer readable medium 516 or on a storage device such as one of the additional devices 514. The server 502 uses its communication interface 518 to communicate with one or more computers 590, for example, over a network 580. Examples of user interface devices 520 include a display, a camera, a speaker, a microphone, a tactile feedback device, a keyboard, and a mouse. The server 502 can store instructions that implement operations associated with the modules described above, for example, on the computer readable medium 516 or one or more additional devices 514, for example, one or more of a floppy disk device, a hard disk device, an optical disk device, or a tape device.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
determining a respective count of occurrences of each unique image pair in a plurality of image pairs wherein each unique image pair comprises:
a first image and a different second image, wherein the first image and the second image were both provided as search results responsive to a single respective query submitted by a user;
wherein the first image was selected by the user a respective amount of time before or after the second image was selected by the user;
wherein the first image of the unique image pairs was viewed for at least a threshold amount of viewing time after selection; and
wherein the respective counts of a first unique image pair and a second unique image pair contribute to each other when the first unique image pair has one of a first and second image having respective identical content to one of the first and second image of the second unique image pair in same respective positions in the first unique image pair and the second unique image pair and at different resource addresses;
receiving data indicative of user selection of an image search result;
based on the received data, selecting one or more of the unique image pairs whose first image matches the selected image search result and that has a respective count that exceeds a threshold wherein the threshold is based on an age of the first image or the second image; and
providing second images from one or more of the selected unique image pairs in response to the user selection of the image search result.

2. The method of claim 1, further comprising providing respective queries of one or more of the selected unique image pairs.

3. The method of claim 1 wherein the provided second images are from a same website or from a same webpage.

4. The method of claim 1 wherein the unique image pairs do not include image pairs wherein the respective amount of time exceeds a second threshold.

5. The method of claim 1 wherein providing the second images comprises ordering the second images based on the respective amounts of time for the selected unique image pairs or based on the respective counts of the selected unique image pairs.

6. The method of claim 1 wherein the count of unique image pairs does not include image pairs that were provided in search results before a particular date.

7. (canceled)

8. The method of claim 1 further comprising determining for a particular unique image pair that the first image of the particular pair is pornographic and identifying the second image of the particular pair as pornographic responsive to the determining.

9. A computer storage medium encoded with a computer program, the program comprising instructions that when executed by data processing apparatus cause the data processing apparatus to perform operations comprising:
determining a respective count of occurrences of each unique image pair in a plurality of image pairs wherein each unique image pair comprises:
a first image and a different second image, wherein the first image and the second image were both provided as search results responsive to a single respective query submitted by a user;
wherein the first image was selected by the user a respective amount of time before or after the second image was selected by the user;
wherein the first image of the unique image pairs was viewed for at least a threshold amount of viewing time after selection; and
wherein the respective counts of a first unique image pair and a second unique image pair contribute to each other when the first unique image pair has one of a first and second image having respective identical content to one of the first and second image of the second unique image pair in same respective positions in the first unique image pair and the second unique image pair and at different resource addresses;
receiving data indicative of user selection of an image search result;
based on the received data, selecting one or more of the unique image pairs whose first image matches the selected image search result and that has a respective count that exceeds a threshold wherein the threshold is based on an age of the first image or the second image; and
providing second images from one or more of the selected unique image pairs in response to the user selection of the image search result.

10. The medium of claim 9, wherein the operations further comprise providing respective queries of one or more of the selected unique image pairs.

11. The medium of claim 9 wherein the provided second images are from a same website or from a same webpage.

12. The medium of claim 9 wherein the unique image pairs do not include image pairs wherein the respective amount of time exceeds a second threshold.

13. The medium of claim 9 wherein providing the second images comprises ordering the second images based on the respective amounts of time for the selected unique image pairs or based on the respective counts of the selected unique image pairs.

14. The medium of claim 9 wherein the count of unique image pairs does not include image pairs that were provided in search results before a particular date.

15. (canceled)

16. The medium of claim 9 wherein the operations further comprise determining for a particular unique image pair that the first image of the particular pair is pornographic and identifying the second image of the particular as pornographic responsive to the determining.

17. A system comprising:
a storage device; and
one or more computers operable to interact with the storage device and to perform operations comprising:
determining a respective count of occurrences of each unique image pair in a plurality of image pairs wherein each unique image pair comprises:
a first image and a different second image, wherein the first image and the second image were both provided as search results responsive to a single respective query submitted by a user;
wherein the first image was selected by the user a respective amount of time before or after the second image was selected by the user;
wherein the first image of the unique image pairs was viewed for at least a threshold amount of viewing time after selection; and
wherein the respective counts of a first unique image pair and a second unique image pair contribute to each other when the first unique image pair has one of a first and second image having respective identical content to one of the first and second image of the second unique image pair in same respective positions in the first unique image pair and the second unique image pair and at different resource addresses;
receiving data indicative of user selection of an image search result;
based on the received data, selecting one or more of the unique image pairs whose first image matches the selected image search result and that has a respective count that exceeds a threshold wherein the threshold is based on an age of the first image or the second image; and
providing second images from one or more of the selected unique image pairs in response to the user selection of the image search result.

18. The system of claim 17, wherein the operations further comprise providing respective queries of one or more of the selected unique image pairs.

19. The system of claim 17 wherein the provided second images are from a same website or from a same webpage.

20. The system of claim 17 wherein the unique image pairs do not include image pairs wherein the respective amount of time exceeds a second threshold.

21. The system of claim 17 wherein providing the second images comprises ordering the second images based on the respective amounts of time for the selected unique image pairs or based on the respective counts of the selected unique image pairs.

22. The system of claim 17 wherein the count of unique image pairs does not include image pairs that were provided in search results before a particular date.

23. (canceled)

24. The system of claim 17 wherein the operations further comprise determining for a particular unique image pair that the first image of the particular pair is pornographic and identifying the second image of the particular pair as pornographic responsive to the determining.
